(19) United States
(12) Patent Application Publication
(10) Pub. No.: US 2026/0098717 A1
(43) Pub. Date: Apr. 9, 2026

(54) Length Measuring Device

(71) Applicant: Kan Mechanical Industry, Inc., Matsuyama-shi Ehime (JP)

(72) Inventor: Eiji KAN, Matsuyama-shi Ehime (JP)

(21) Appl. No.: 19/243,652

(22) Filed: Jun. 19, 2025

Related U.S. Application Data
(63) Continuation-in-part of application No. PCT/JP2023/038639, filed on Oct. 26, 2023.

(30) Foreign Application Priority Data
Dec. 21, 2022 (JP) 2022-203872

(51) Int. Cl. G01B 3/20; B23Q 17/20; B23Q 17/22

(52) U.S. Cl. CPC G01B 3/20; B23Q 17/20; B23Q 17/22

(57) ABSTRACT

A length measuring device is equipped with a slide rail, and with a sliding unit that is slidably mounted to the slide rail and has a sliding body, a length measuring unit which measures a distance slid by the sliding body with respect to the slide rail, a temporary securer, a fine adjustment mechanism having a feed screw that couples the sliding body and the temporary securer so as to permit relative motion therebetween in the sliding direction, a first clamp for securing the sliding body, and a temporary securing clamp for securing the temporary securer. The fine adjustment mechanism is equipped with a coil spring. The coil spring is disposed coaxially with the feed screw and between the sliding body and the temporary securer, and causes the sliding body and the temporary securer to tend to be pushed toward or pulled away from each other.

### CROSS-REFERENCE TO RELATED APPLICATION(S), BENEFIT/PRIORITY CLAIM(S), AND INCORPORATION(S) BY REFERENCE

This application is a continuation-in-part of and claims benefit under 35 USC 120 and 365(c) to copending International Application No PCT/JP2023/038639, entitled “Length Measuring Device”, filed 26 October 2023; and further claims benefit of priority under 35 USC 119(a)-(d) to Japanese Patent Application No 2022-203872, entitled “Length Measuring Device”, filed 21 December 2022, the contents of all of which applications are incorporated herein in their entireties by reference. STATEMENT REGARDING PRIOR DISCLOSURES BY INVENTOR UNDER 37 CFR 1.77(b)(6) The following patents and published patent applications are disclosures by, originating with, and/or attributable to the inventor of the present application: WO 2015 122206 A1 (“Length Measuring Device”; 20 August 2015); JP 2015 152400 A (“Length Measuring Device”; 24 August 2015); JP 2016 155176 A (“Length Measuring Device”; 1 September 2016); WO 2016 136103 A1 (“Length Measuring Device”; 1 September 2016); CN 205981013 U (“Length Measuring Device”; 22 February 2017); DE 112015006210 T5 (“Length Measuring Device”; 2 November 2017); VN 1 055007 (“Length Measuring Device”; 27 November 2017); TH 1701004775 A (“Length Measuring Device”; 19 July 2018); JP 6601939 B2 (“Length Measuring Device”; 6 November 2019); WO 2021 230024 A1 (“Length Measuring Apparatus”; 18 November 2021); JP 2021 181974 A (“Length Measuring Apparatus”; 25 November 2021); US 2022 170728 A1 (“Length Measuring Apparatus”; 2 June 2022); WO 2022 270007 A1 (“Length Measuring Device”; 29 December 2022); JP 2023-001416 A (“Length Measuring Device”; 6 January 2023); DE 112021002736 T5 (“Length Measuring Apparatus”; 23 February 2023); US 11852469 B2 (“Length Measuring Apparatus”; 26 December 2023); US 2024 0060763 A1 (“Length Measuring Apparatus”; 22 February 2024); WO 2024 135088 A1 (“Length Measuring Device”; 27 June 2024); and JP 2024 088863 A (“Length Measuring Device”; 3 July 2024).

### FIELD OF THE INVENTION

The present invention relates to a length measuring device that measures length(s) of workpiece(s) machined by machining device(s).

### BACKGROUND

Machining devices may carry out various types of machining such as cutting, boring, scribing, and so forth of workpieces being machined. To use such a machining device to carry out machining of a workpiece at a precise cutting location, boring location, scribing location, or other such machining location, there are situations in which the length from a desired place on the workpiece to the machining location must be precisely measured.

Some length measuring devices that measure lengths of workpieces machined by machining devices are capable of precise positioning by means of a fine adjustment mechanism.

Where such length measuring devices employ screw-type feed mechanisms to carry out fine adjustment of the location of the sliding unit, the amount of play (i.e., gap or backlash) which is present in the mechanism may cause occurrence of misalignment when the sliding unit is secured by means of a clamp.

There is therefore a need to provide a length measuring device capable of fine adjustment by means of a screw-type feed mechanism in which it is possible to prevent occurrence of misalignment due to play in the screw-type feed mechanism.

### SUMMARY OF INVENTION

A length measuring device associated with one embodiment of the present invention may be used in combination with a workpiece machining device to measure a length of a workpiece machined by the workpiece machining device.

One embodiment of a length measuring device in accordance with the present invention may comprise a slide rail capable of being made to have a fixed positional relationship to the workpiece machining device when the length is measured.

The length measuring direction may further comprise a sliding unit that is slidably mounted to the slide rail.

The sliding unit may comprise a sliding body that is slidably attached to the slide rail.

The sliding unit may further comprise a length measuring unit that measures a distance slid by the sliding body with respect to the slide rail.

The sliding unit may further comprise a temporary securer.

The sliding unit may further comprise a fine adjustment mechanism. The fine adjustment mechanism may employ a feed screw that couples the sliding body and the temporary securer so as to permit relative motion therebetween in a sliding direction of the sliding body.

The sliding unit may further comprise a first clamp for securing the sliding body with respect to the slide rail.

The sliding unit may further comprise a temporary securing clamp for securing the temporary securer with respect to the slide rail.

In some embodiments, the fine adjustment mechanism is equipped with a compression coil spring, disposed coaxially with the feed screw and between the sliding body and the temporary securer, for reducing backlash between the sliding body and the temporary securer.

In some embodiments, the compression coil spring may be arranged so as to cause the sliding body and the temporary securer to tend to be pushed toward each other.

In some embodiments, the compression coil spring may be arranged so as to cause the sliding body and the temporary securer to tend to be pulled away from each other.

### BENEFIT OF INVENTION

A length measuring device in accordance with one or more embodiments of the present invention may make it possible, in the context of a length measuring device capable of fine adjustment by means of a screw-type feed mechanism, to suppress occurrence of misalignment due to play in the screw-type feed mechanism.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a length measuring device associated with an embodiment of the present invention.

FIG. 2 is an enlarged perspective view of the primary components of a length measuring device associated with an embodiment of the present invention.

FIG. 3 is an enlarged perspective view of the primary components of a length measuring device associated with an embodiment of the present invention.

FIG. 4 is an enlarged view of the primary components of a length measuring device associated with an embodiment of the present invention.

FIG. 5 is an enlarged view of the primary components of a length measuring device associated with an embodiment of the present invention.

FIG. 6 is a perspective view showing a length measuring device associated with an embodiment of the present invention while it is in use.

### EMBODIMENTS FOR CARRYING OUT INVENTION

Length measuring device 1, which is associated with an embodiment of the present invention, will be described hereinbelow with reference to the drawings. The present embodiment will be described in terms of length measuring device 1 which measures the length of a workpiece to be cut to a prescribed length by cutting device 90 which is a workpiece machining device.

Length measuring device 1 is equipped with base unit 2 which is secured to cutting device 90, described below, and with sliding unit 3 which is slidably mounted with respect to base unit 2 Base unit 2 is equipped with plate-like base platform 11, and with slide rail 15 which is mounted on base platform 11.

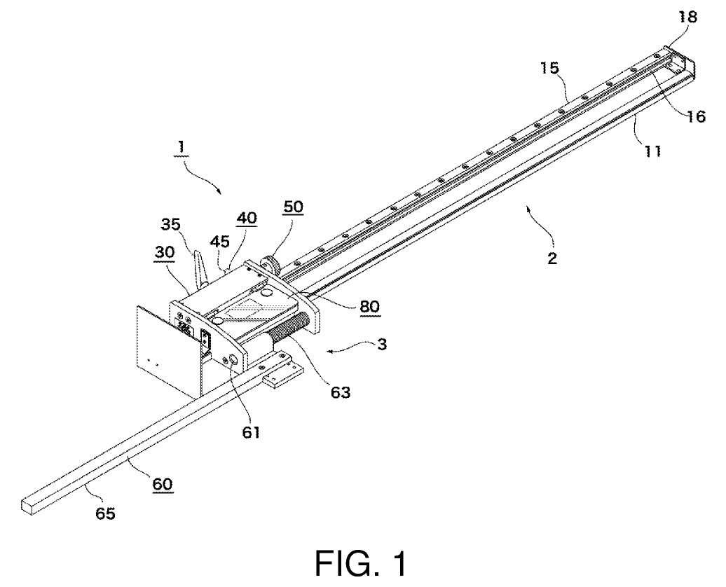

Formed at slide rail 15 to either side in the sliding direction is a pair of slide grooves 16 that extend in the sliding direction. Slide stopper 18, which prevents sliding unit 3 from becoming detached from the end of slide rail 15, is mounted at one end (what is more or less the right end at FIG. 1) of slide groove 16.

Sliding unit 3—which is provided with sliding body 30; temporary securer 40; fine adjustment mechanism 50 for fine adjustment of the positional relationship in the sliding direction between sliding body 30 and temporary securer 40; arm unit 60; and digital length measuring unit 80—is slidably mounted on slide rail 15 by way of sliding body 30.

Sliding body 30 is equipped with case 31; first clamp 35 for securing case 31 with respect to slide rail 15; and linear guide 39 which is secured to the bottom surface of case 31. Case 31 is equipped with frames 31a which are located at either end in the sliding direction; and with body block 31b which is located between the frames 31a at the two ends.

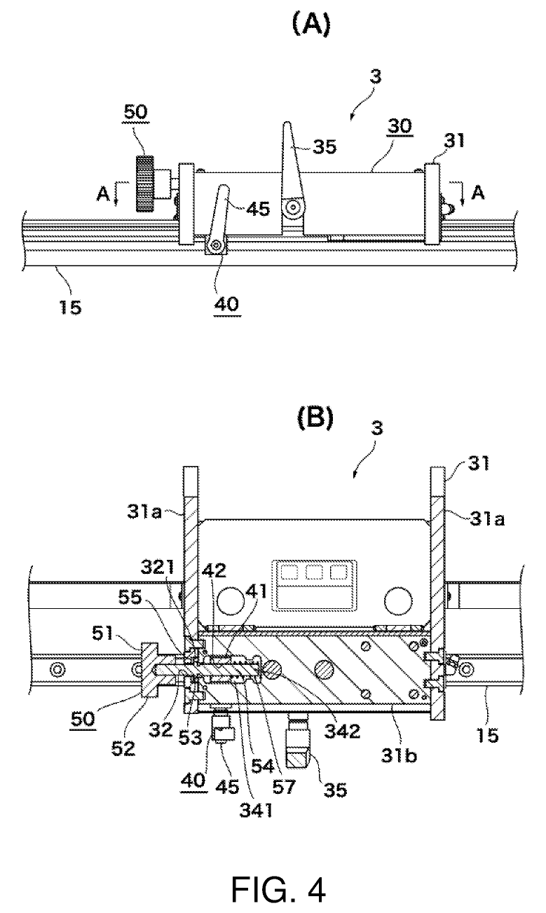

Body block 31b is such that formed thereat is enclosing space 341 for housing the upper portion of temporary securer 40. (B) at FIG. 4, being a view of a section taken along A-A at (A) in FIG. 4, is a horizontal sectional view of the portion corresponding to enclosing space 341. Formed at a portion of case 31 that abuts enclosing space 341 is male threaded insertion hole 32, through which feed screw 51 of fine adjustment mechanism 50, described below, passes. The inside diameter of male threaded insertion hole 32 is larger than the outside diameter of the shaft of feed screw 51.

Formed at an entrance portion on the enclosing space 341 side (inside) of male threaded insertion hole 32 of frame 31a is flange groove 321 for engagement with flange 53 formed at feed screw 51. Case 31 is such that, while flange 53 of feed screw 51 is engaged with flange groove 321, inasmuch as flange 53 is pressed on by the side face of body block 31b it will be prevented from coming free from flange groove 321 in the direction of enclosing space 341. Case 31 is equipped with arm retaining unit 345 for retaining arm unit 60, described below.

Furthermore, provided on body block 31b at a portion thereof corresponding to enclosing space 341 is movement constraining projection 342 for constraining the range of movement of temporary securing block 41 so as to prevent temporary securing block 41, described below, from moving too far in a direction such as would cause compression of compression coil spring 57 and damage to compression coil spring 57.

Movement constraining projection 342, which is a portion at which the side face of body block 31b that faces enclosing space 341 is made to protrude into enclosing space 341, is such that when temporary securing block 41 is made to move in a direction (toward the right at FIG. 4) such as would cause compression of compression coil spring 57, it is prevented from moving further in the same direction as a result of coming in contact with movement constraining projection 342. This makes it possible to definitively prevent damage to compression coil spring 57 due to erroneous operation of fine adjustment mechanism 50 or the like.

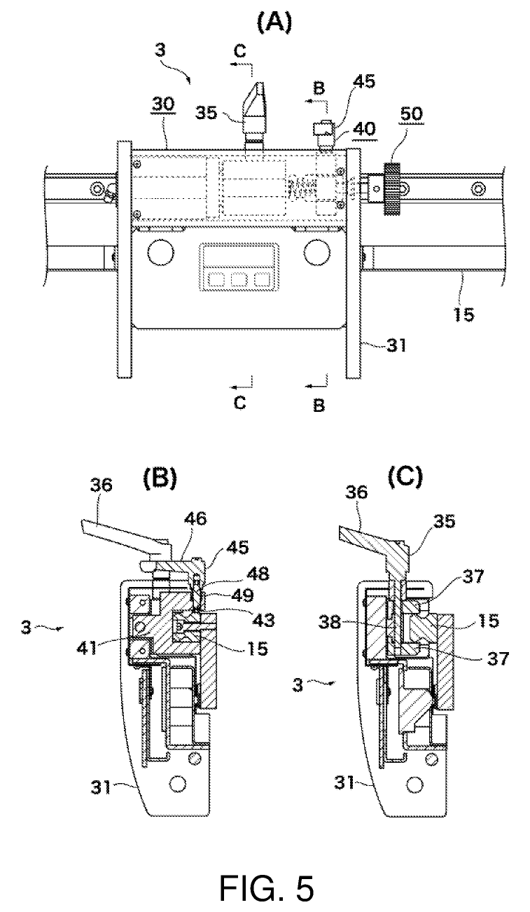

First clamp 35—which is equipped with clamp lever 36, vise 37, and clamp shaft 38—is secured and mounted to case 31. (C) at FIG. 5, being a view of a section taken along C-C at (A) in FIG. 5, is a view of a vertical section perpendicular to the sliding direction, i.e., the length measuring direction, of the portion at which first clamp 35 is mounted. Clamp shaft 38 is installed in a direction orthogonal to the sliding direction.

Clamp lever 36 is secured and mounted to one end of clamp shaft 38, it being possible to cause clamp shaft 38 to rotate about its axis as a result of rotation of clamp lever 36 about the axis of clamp shaft 38. Vise 37, which is rotatably supported by clamp shaft 38, is constituted from a pair of blocks arranged so as to straddle slide rail 15. Clamp shaft 38 has screw threads, not shown, formed thereon, rotation thereof making it possible to adjust the distance between the pair of blocks from which vise 37 is constituted.

First clamp 35 is therefore such that actuation of clamp lever 36 permits switching between a secured state in which sliding body 30 is secured relative to slide rail 15, and an unsecured state in which sliding body 30 is free to slide relative to slide rail 15. Slide rail 15 is straddled and squeezed by vise 37 when in the secured state as shown at (C) in FIG. 5; vise 37 is made to retract and become separated from slide rail 15 when placed in the unsecured state.

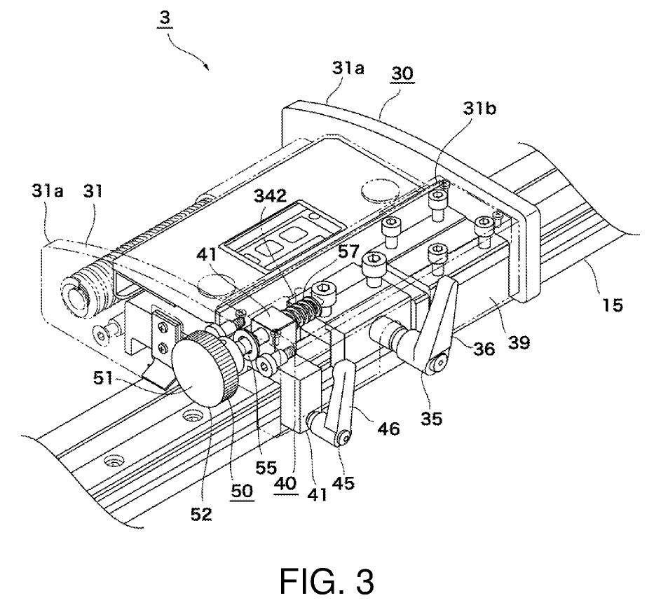

Linear guide 39 is secured to the bottom surface of case 31, being attached thereto such that it is smoothly slidable relative to slide rail 15 (see FIG. 3).

Temporary securer 40 is equipped with temporary securing block 41 which is arranged at enclosing space 341 of sliding body 30, and temporary securing clamp 45 for securing temporary securing block 41 with respect to slide rail 15. Temporary securing block 41 is such that, within enclosing space 341, the upper portion thereof is of such shape and size as to permit relative motion in the sliding direction with respect to sliding body 30, while the lower portion thereof is of such shape and size as to at least partially enclose slide rail 15 from either side thereof.

Formed at temporary securing block 41 are feed screw female threaded hole 42 which extends in the sliding direction and into which feed screw 51 of fine adjustment mechanism 50, described below, is threadedly inserted; and temporary clamp female threaded hole 43 which is provided at the lower portion thereof and into which clamp shaft 48 of temporary securing clamp 45 is threadedly inserted.

Temporary securing clamp 45 is equipped with clamp lever 46; clamp shaft 48; and temporary clamp coil spring 49, which is coaxial with clamp shaft 48 and which is provided so as to be straddled between temporary securing block 41 and clamp lever 46. (B) at FIG. 5, being a view of a section taken along B-B at (A) in FIG. 5, is a view of a vertical section perpendicular to the sliding direction (length measuring direction) of the portion at which temporary securing clamp 45 is mounted. Clamp shaft 48 is installed in a direction orthogonal to the sliding direction.

Clamp lever 46 is secured and mounted to one end of clamp shaft 48, it being possible to cause clamp shaft 48 to rotate about its axis as a result of rotation of clamp lever 46 about the axis of clamp shaft 48. Clamp shaft 48 has screw threads, not shown, formed thereon, rotation thereof making it possible to adjust the positional relationship in the direction of the axis of clamp shaft 48 between it and temporary securing block 41.

The tip of clamp shaft 48 protrudes toward the side thereof which faces slide rail 15 at the lower portion of temporary securing block 41, it being possible as a result of actuation of clamp lever 46 to carry out switching between a secured state in which the tip of clamp shaft 48 is pressed against slide rail 15 and temporary securing block 41 is secured relative to slide rail 15, and an unsecured state in which the tip of clamp shaft 48 is retracted from slide rail 15 and temporary securing block 41 is free to slide relative to slide rail 15.

The tip of clamp shaft 48 comes in contact with the side face of slide rail 15 when in the secured state as shown at (B) in FIG. 5; the tip of clamp shaft 48 is made to retract and become separated from slide rail 15 when placed in the unsecured state. Note that the component employed as temporary securing clamp 45 may be such that the tightening force (securing force) thereof is weaker than that of first clamp 35.

Fine adjustment mechanism 50—which is a screw-type feed mechanism that causes sliding body 30 (case 31) and temporary securer 40 (temporary securing block 41) to be coupled so as to permit relative motion therebetween—is equipped with feed screw 51 which is male-threaded, and compression coil spring 57 which is installed so as to be coaxial with feed screw 51. Feed screw 51 is equipped with knob 52 which is mounted at the head portion thereof; flange 53 which is formed near the head portion; male threaded portion 54 which is formed at the tip side thereof; and oilless washer 55 which is installed between case 31 (frame 31a) and flange 53 at the bottom of flange groove 321 (see FIG. 3, FIG. 4, and so forth).

Feed screw 51 is such that, while flange 53 is in a captured state in which it is engaged with flange groove 321 formed at the inside entrance of male threaded insertion hole 32 formed in frame 31a, flange 53 is pressed on by body block 31b so as to be prevented from coming free from flange groove 321. Movement of feed screw 51 relative to case 31 is therefore constrained in the sliding direction, feed screw 51 and case 31 being made to have a fixed positional relationship in the sliding direction.

Male threaded portion 54 of feed screw 51 is threadedly inserted into feed screw female threaded hole 42 formed in temporary securing block 41, threaded engagement between male threaded portion 54 and female threaded hole 42 causing there to be relative motion in the sliding direction between feed screw 51 and temporary securing block 41 as a result of the travel of the screw when feed screw 51 is rotated about its axis.

As described above, feed screw 51 and case 31 have a fixed positional relationship in the sliding direction. Rotation of feed screw 51 about its axis therefore causes there to be relative motion in the sliding direction between case 31 (sliding body 30) and temporary securing block 41 (temporary securer 40).

The present embodiment may, for example, be constituted such that feed screw 51 and case 31 move 1.25 mm in the sliding direction when feed screw 51 makes one revolution, permitting fine adjustment of the positional relationship between sliding body 30 and temporary securer 40 to be carried out as a result of rotation of feed screw 51.

In accordance with the present embodiment, compression coil spring 57 is installed coaxially with feed screw 51, and in a compressed state between sliding body 30 and temporary securer 40, so that sliding body 30 and temporary securer 40 tend to be pushed toward each other. In accordance with the present embodiment, male threaded portion 54 of feed screw 51 passes through compression coil spring 57.

Here, it is entirely possible that engagement between male threaded portion 54 of feed screw 51 and female threaded hole 42 of temporary securing block 41 is such that the amount of play (gap or backlash) which is present in the axial direction will not be small; moreover, it is also likely that engagement between flange 53 of feed screw 51 and flange groove 321 of case 31 will be such that there will be some amount of play (gap or backlash) which is present in the axial direction so as to permit rotation of feed screw 51.

For this reason, during the nontemporary securing operation described below, at a time when sliding body 30 is being nontemporarily secured at a precise location with respect to slide rail 15 by first clamp 35 based on an accurate value measured by digital length measuring unit 80, there are situations in which actuation of clamp lever 36 causes sliding body 30 to move slightly with respect to slide rail 15, causing occurrence of a slight discrepancy, e.g., on the order of 0.1 mm, between the value measured by digital length measuring unit 80 before nontemporary securing versus the value measured by digital length measuring unit 80 after nontemporary securing.

In accordance with the present embodiment, provision of compression coil spring 57, in an arrangement in which an elastic force is made to cause sliding body 30 and temporary securer 40 which are coupled by fine adjustment mechanism 50 to be pushed toward each other in the sliding direction, makes it possible to prevent such slight misalignment due to play in fine adjustment mechanism 50 from occurring during the nontemporary securing operation.

Furthermore, whereas provision of compression coil spring 57 might cause flange 53 of feed screw 51 to be pressed against the bottom of flange groove 321, as a result of which feed screw 51 might become unable to rotate smoothly about its axis, provision, in accordance with the present embodiment, of oilless washer 55 at a location which is between body block 31b and flange 53 within flange groove 321 and at which compression coil spring 57 causes flange 53 to be pressed against body block 31b, i.e., at the bottom of flange groove 321, permits smooth actuation of feed screw 51.

Note that whereas the constitution of the present embodiment is such that compression coil spring 57 is installed on feed screw 51 between temporary securing block 41 and body block 31b at a location which is toward the tip (toward the right at FIG. 4) from temporary securing block 41 so that the two (the portions thereof that engage with feed screw 51) tend to be pushed toward each other, it is also possible to adopt a constitution in which compression coil spring 57 is provided thereon between temporary securing block 41 and body block 31b at a location which is toward knob 52 (toward the left at FIG. 4) from temporary securing block 41 so that the two (the portions thereof that engage with feed screw 51) tend to be pulled away from each other. Note, however, that the procedure for assembling sliding unit 3 will be simpler when compression coil spring 57 is provided toward the tip from temporary securing block 41.

Detailed description will next be given with regard to a procedure that may be employed for positioning and securing sliding body 30 at a desired location on slide rail 15 as fine adjustment mechanism 50 is used to carry out fine adjustment of the location reached as a result of sliding.

First, a temporary securing operation might be performed in which sliding unit 30 is temporarily secured in the vicinity of a desired location on slide rail 15. More specifically, while observing the measured value at display unit 82 of digital length measuring unit 80, sliding body 30 might be slid by hand relative to slide rail 15 by way of linear guide 39 until a location is reached that causes approximately the desired length to be obtained.

After sliding body 30 has been moved to the vicinity of the desired location, temporary securing clamp 45 of temporary securer 40 might be closed to cause temporary securer 40 to be reliably secured to slide rail 15. At this time, because temporary securer 40 is coupled to sliding body 30 by way of fine adjustment mechanism 50, sliding body 30 will also indirectly be temporarily secured with respect to slide rail 15.

Next, a fine adjustment operation might be performed in which fine adjustment mechanism 50 is used to carry out fine adjustment of the location reached as a result of sliding of sliding body 30 relative to slide rail 15, and to precisely position it at the desired location to be reached as a result of sliding. More specifically, while again observing the measured value at display unit 82, by turning knob 52, sliding body 30 may by means of a screw-type feed mechanism be made to move small distances in the sliding direction, i.e., in the length measuring direction, relative to temporary securer 40 which is secured to slide rail 15.

In addition, at a location where the measured value at display unit 82 exactly matches the desired length, fine adjustment carried out by means of screw-type feed action might be terminated, and first clamp 35 might be closed to cause sliding body 30 to be secured to slide rail 15 (nontemporary securing operation). This will permit sliding body 30 to be precisely and reliably secured at the desired location.

At this time, because in accordance with the present embodiment a constitution is adopted in which compression coil spring 57 causes temporary securer 40 and sliding body 30 to tend to be pushed toward each other in the sliding direction, this will make it possible to prevent any slight misalignment that might otherwise occur due to play in fine adjustment mechanism 50.

Thus, in accordance with the present embodiment which is provided with a temporary securing operation, a fine adjustment operation, and a nontemporary securing operation, sliding unit 3 may be quickly moved by hand during the temporary securing operation, and fine adjustment of the location reached as a result of sliding may thereafter be carried out during the fine adjustment operation, permitting precise positioning (the nontemporary securing operation) to be carried out in a short overall amount of time.

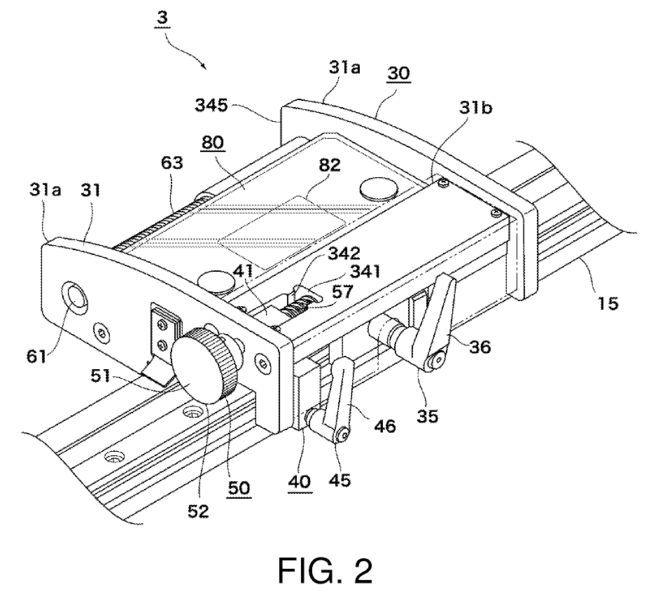

Furthermore, in accordance with the present embodiment, temporary securer 40 may be arranged within enclosing space 341 which is formed in the vicinity of the center of case 31 of sliding body 30 (see FIG. 2, (B) at FIG. 4, and so forth). For this reason, at a time when fine adjustment of the positional relationship between temporary securer 40 and sliding body 30 in the sliding direction is being carried out by means of fine adjustment mechanism 50, the range of relative motion of temporary securer 40 can be constrained so as to be within enclosing space 341. As a result, it will be possible to prevent feed screw 51 from coming free of female threaded hole 42 due to excessive rotation of feed screw 51.

The location at which temporary securer 40 is installed can of course be varied as appropriate so long as it is at a location permitting it to be coupled in such fashion that it can be made to slide with respect to sliding body 30 by means of fine adjustment mechanism 50; for example, it may be installed so that it and case 31 of sliding body 30 are mutually adjacent.

Continuing with description, in accordance with the present embodiment, arm unit 60 is equipped with arm support shaft 61 which is retained by arm retaining unit 345 of sliding body 30, spring 63, and workpiece contacting arm 65. When the length of the workpiece is being measured, the portion at the tip of workpiece contacting arm 65 contacts the cutting device (i.e., the side face of cutting blade 91 of cutting device 90) or the workpiece.

In accordance with the present embodiment, workpiece contacting arm 65 is rotatably supported in such fashion as to permit sliding in the sliding direction by arm support shaft 61 which extends in the sliding direction. In accordance with the present embodiment, spring 63, which is installed in coaxial fashion with respect to arm support shaft 61 and which applies a restoring force to workpiece contacting arm 65 that acts in the direction of the tip thereof, absorbs impacts produced during collisions with the tip of workpiece contacting portion 65.

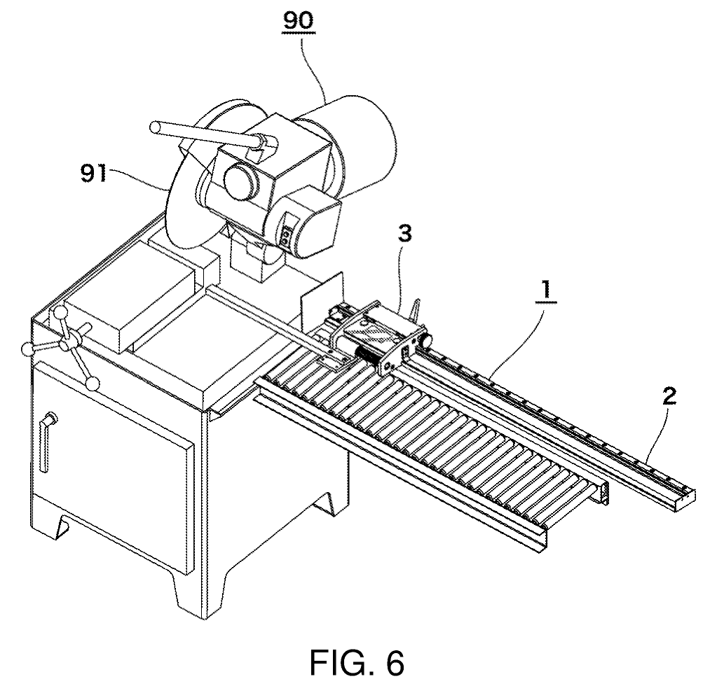

The foregoing being description of the constitution of length measuring device 1 in accordance with one embodiment, description will next be given with regard to a procedure that may be employed when a workpiece is to be cut to a prescribed length by cutting device 90 as the length of the workpiece is measured by length measuring device 1. FIG. 6 is a perspective view showing a length measuring device associated with the present embodiment while it is in use.

In accordance with the present embodiment, use of length measuring device 1 in combination with cutting device 90 makes it possible to cause a workpiece to be cut to a desired length at a desired cutting location (machining location) by cutting device 90 as a result of carrying out measurement of length by length measuring device 1.

More specifically, before placing the workpiece thereon, the tip portion of arm unit 60 that comes in contact with the workpiece might be positioned at the cutting location serving as machining location (the location that comes in contact with the side face of cutting blade 91 of cutting device 90), and while in this state, the measured value at digital length measuring unit 80 might be reset to 0.

Next, sliding unit 3 might be made to slide a desired length away from the cutting location such as will permit the workpiece to be cut to the desired length. At this time, when sliding unit 3 is made to slide, display unit 82 of digital length measuring unit 80 might display the distance moved from the location (cutting location) at which resetting was carried out.

In addition, sliding unit 3 might be secured at a location which causes the measured value at display unit 82 to be the value of the desired length. In carrying out securing of sliding unit 3, the foregoing temporary securing operation might first be performed to cause the measured value at display unit 82 to be in the vicinity of the desired value, and while in this state, temporary securing clamp 45 might be used to cause temporary securer 40 to be secured with respect to slide rail 15. At this time, the measured value at display unit 82 need not match the value of the desired length.

The foregoing fine adjustment operation might then be performed to achieve positioning such that the measured value at display unit 82 exactly matches the value of the desired length, and while in this state, first clamp 35 might be used to cause sliding body 30 to be secured with respect to slide rail 15 during the nontemporary securing operation. At this time, if the arrangement is such that sliding body 30 and temporary securer 40 tend to be pushed toward each other by compression coil spring 57, this will make it possible during nontemporary securing to prevent any misalignment that might otherwise occur due to play in fine adjustment mechanism 50.

Because this causes the distance from the cutting location to the tip portion of workpiece contacting arm 65 to be the desired length, it will be possible by placing the workpiece at the cutting location in such fashion that one end thereof contacts the tip of workpiece contacting portion 65 to cause the workpiece to be cut to the desired length.

While embodiments of the present invention have been described above, the present invention is not limited to the embodiments that have been described above, a great many variations being possible without departing from the gist of the present invention. For example, the shapes, sizes, materials and so forth of the respective parts that make up the length measuring device associated with the present embodiment may be varied as appropriate.

Furthermore, while the present embodiment was described in terms of an example in which a cutting device served as machining device for use in combination with the length measuring device, it is possible to employ in combination therewith a boring device that bores a hole at a prescribed location on a workpiece, a scribing device that scribes a line at a prescribed location on a workpiece, or any of various other types of machining devices.

Furthermore, whereas the constitution of the foregoing embodiment was such that a length measuring device was directly secured to and mounted on the workpiece machining device, it being sufficient that the constitution be such as to allow the length measuring device to be stably secured relative to the workpiece machining device in such fashion as to permit the length of the workpiece to be measured at a location in the vicinity of the workpiece machining device, a standalone length measuring device may be installed on the floor in the vicinity of the workpiece machining device.

### EXPLANATION OF REFERENCE NUMERALS

1 Length measuring device

2 Base unit

11 Base platform

15 Slide rail

16 Slide groove

18 Slide stopper

3 Sliding unit

30 Sliding body

31 Case

31a Frame

31b Body block

32 Male threaded insertion hole

321 Flange groove

341 Enclosing space

342 Movement constraining projection

345 Arm retaining unit

35 First clamp

36 Clamp lever

37 Vise

38 Clamp shaft

39 Linear guide

40 Temporary securer

41 Temporary securing block

42 Feed screw female threaded hole

43 Temporary clamp female threaded hole

45 Temporary securing clamp

46 Clamp lever

48 Clamp shaft

49 Temporary clamp coil spring

50 Fine adjustment mechanism

51 Feed screw

52 Knob

53 Flange

54 Male threaded portion

55 Oilless washer

57 Compression coil spring

60 Arm unit

61 Arm support shaft

63 Spring

65 Workpiece contacting arm

80 Digital length measuring unit

82 Display unit

90 Cutting device

91 Cutting blade

What is claimed is:

1. A length measuring device for use in combination with a workpiece machining device to measure a length of a workpiece machined by the workpiece machining device, the length measuring device comprising:
a slide rail capable of being made to have a fixed positional relationship to the workpiece machining device when the length is measured; and
a sliding unit that is slidably mounted to the slide rail, the sliding unit having
a sliding body that is slidably attached to the slide rail;
a length measuring unit that measures a distance slid by the sliding body with respect to the slide rail;
a temporary securer;
a fine adjustment mechanism having a feed screw that couples the sliding body and the temporary securer so as to permit relative motion therebetween in a sliding direction of the sliding body;
a first clamp for securing the sliding body with respect to the slide rail; and
a temporary securing clamp for securing the temporary securer with respect to the slide rail;
wherein the fine adjustment mechanism is equipped with a compression coil spring, disposed coaxially with the feed screw and between the sliding body and the temporary securer, for reducing backlash between the sliding body and the temporary securer.

2. The length measuring device according to claim 1 wherein
a flange is formed at the feed screw, and a flange groove is formed at the sliding body, capturing of the flange by the flange groove causing the feed screw and the sliding body to have a fixed positional relationship in the sliding direction; and
at the flange groove, an oilless washer is installed at a location which is between the flange and the sliding body and at which the compression coil spring causes the flange to be pressed against the sliding body.

3. The length measuring device according to claim 1 wherein
the temporary securer is such that a portion thereof is installed within a space at least partially enclosed by the sliding body, a first range of relative movement thereof in the sliding direction with respect to the sliding body being constrained by the sliding body, and the compression coil spring is also installed within the space; and
the sliding body is equipped with a movement constraining projection that protrudes into the space and that constrains a second range of relative movement of the temporary securer in a direction such as would cause shortening of the compression coil spring so as to prevent damage to the compression coil spring.

4. The length measuring device according to claim 2 wherein
the temporary securer is such that a portion thereof is installed within a space at least partially enclosed by the sliding body, a first range of relative movement thereof in the sliding direction with respect to the sliding body being constrained by the sliding body, and the compression coil spring is also installed within the space; and
the sliding body is equipped with a movement constraining projection that protrudes into the space and that constrains a second range of relative movement of the temporary securer in a direction such as would cause shortening of the compression coil spring so as to prevent damage to the compression coil spring.

5. The length measuring device according to claim 1 wherein the compression coil spring is installed on the feed screw at a location which is toward a tip thereof from the temporary securer.

6. The length measuring direction according to claim 3 wherein the second range of relative movement is smaller than the first range of relative movement.

7. The length measuring direction according to claim 3 wherein the second range of relative movement is coextensive with the first range of relative movement.

8. The length measuring direction according to claim 4 wherein the second range of relative movement is smaller than the first range of relative movement.

9. The length measuring direction according to claim 4 wherein the second range of relative movement is coextensive with the first range of relative movement.

10. The length measuring direction according to claim 1 wherein the compression coil spring is arranged so as to cause the sliding body and the temporary securer to tend to be pushed toward each other by the compression coil spring.

11. The length measuring direction according to claim 1 wherein the compression coil spring is arranged so as to cause the sliding body and the temporary securer to tend to be pulled away from each other by the compression coil spring.
